(19) United States
(12) Patent Application Publication
(10) Pub. No.: US 2012/0052153 A1
(43) Pub. Date: Mar. 1, 2012

(54) DOG EXCREMENT VISIBILITY ENHANCEMENT

(76) Inventors: Joshua M. Ip, Camano Island, WA (US); Colette M. Ip, Camano Island, WA (US)

(21) Appl. No.: 13/266,270

(22) PCT Filed: Apr. 26, 2010
(86) PCT No.: PCT/US10/32402

§ 371 Date: Oct. 26, 2011

(30) Foreign Application Priority Data
Apr. 27, 2009 (US) 61172877

(51) Int. Cl. A23K 1/18

(52) U.S. Cl. 426/2; 426/531

(57) ABSTRACT

The present invention in several embodiments is an excrement visibility enhancement substance, animal food formulation, and method of increasing excrement visibility. In a preferred embodiment the invention could be a pet food with the following formulation per batch: 100 grams (˜3.5 oz) flour, 103 grams (˜3.6 oz) oats, 20 grams (˜0.7 oz) flax seed, 110 grams (˜3.9 oz), 7.5 grams (˜0.3 oz) dye FD & C Red 3 powder, 104 grams (˜3.7 oz) Apple, and 105 grams (˜3.7 oz) Carrots. Alternatively, excrement coloring substance FD & C blue 1, FD & C blue 2, FD & C green 3, cranberry extract, cherry extract, cranberry extract, and beet extract have shown promise; and could be used with or in lieu of FD & C Red 3 in the above formulation. The above formulation can be modified to accommodate any animal, especially any domesticated animal.

### FIELD OF THE INVENTION

The present invention relates, in general, to animal excrement visibility, more particularly, this invention relates to a method of making dog and other animal excrement more visible for avoidance, collection, novelty, etc.

### BACKGROUND OF THE INVENTION

Prior to the conception and development of the present invention, dog excrement in a yard or other place can be difficult to avoid. Even when persons are actively looking for dog or other animal excrement they can inadvertently step in it or have difficulty finding it for collection.

### SUMMARY OF THE INVENTION

The present invention in several embodiments is an excrement visibility enhancement substance, animal food formulation, and method of increasing excrement visibility.

The Applicants have discovered, in accordance with the present invention, a method of coloring animal excrement.

The Applicants have discovered, in accordance with the present invention a method of coloring animal excrement prior to excretion.

The Applicants have discovered, in accordance with the present invention a method of coloring animal excrement prior to excretion for easy detection and avoidance.

The Applicants have discovered, in accordance with the present invention a method of distinctively coloring animal excrement.

The Applicants have discovered, in accordance with the present invention a method of distinctively coloring animal excrement for determining which of a number of animals produced the excrement.

In a preferred embodiment the invention could be a pet food with the following formulation per batch: 100 grams (˜3.5 oz) flour, 103 grams (˜3.6 oz) oats, 20 grams (˜0.7 oz) flax seed, 110 grams (˜3.9 oz), 7.5 grams (˜0.3 oz) dye FD & C Red 3 powder, 104 grams (˜3.7 oz) Apple, and 105 grams (˜3.7 oz) Carrots. Alternatively, excrement coloring substance FD & C blue 1, FD & C blue 2, FD & C green 3, cranberry extract, cherry extract, cranberry extract, and beet extract have shown promise; and could be used with or in lieu of FD & C Red 3 in the above formulation. The above formulation can be modified to accommodate any animal, especially any domesticated animal.

### BRIEF DESCRIPTION OF THE DRAWINGS

FIG. 1 is a perspective view of the invention in use according to one embodiment.

FIG. 2 is a perspective of the invention according to one embodiment of the invention.

FIG. 3 is a perspective view of the invention in use according to another embodiment.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

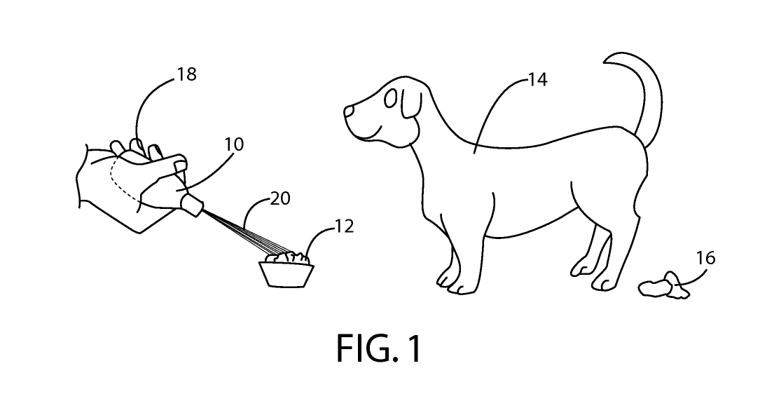

Reference is now made, more particularly, to FIGS. 1-3.

There is a need for a method of making animal excrement more visible to humans to facilitate detection and identification of the excrement. The increased visibility will aid in avoidance and collection of the excrement.

Accordingly, an excrement visibility enhancement substance and method of increasing excrement visibility is provided. This is accomplished by providing a visibility enhancing substance 20 to the animal 14 of concern for consumption by said animal. The animal then excretes the substance in its excrement 16.

For example, reference is made to FIG. 1, the user 18 could provide the visibility enhancing substance 20 as a supplement 20 to the animal's food 12 or the substance could be incorporated into the food 12 upon production. Animal 14 then eats said food 12 with visibility enhancing substance 20. The animal 14 then later excretes excrement 16 with visibility enhancing substance 20, thus making excrement 16 more visible. Alternatively, the ingredients of animal's food 12 could be bleached upon production to make the excrement 16 lighter in color or to make the visibility enhancing substance 20 more visible in excrement 16.

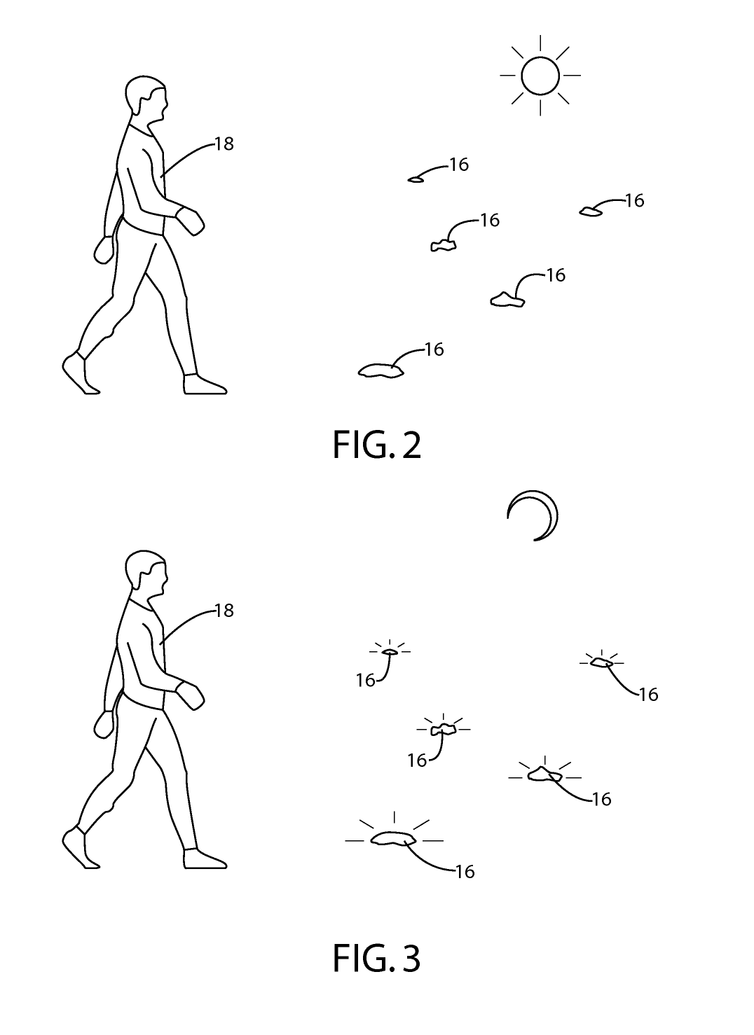

Reference is now made to FIG. 2, the user 18 can now navigate a field of excrement 16 without unwanted contact with excrement 16. Alternatively, user 18 can easily identify the excrement 16 for easy collection. In this embodiment the visibility enhancing substance 20 is an acid proof dye, but other substances that change the color of animal excrement could be used, such as, other dyes, food colorings, barium meal, or small non-toxic flecks or particles of colored substances.

Reference is now made to FIG. 3, the user 18 can now navigate a field of excrement 16 without unwanted contact with excrement 16. Alternatively, user 18 can easily identify the excrement 16 for easy collection. In this embodiment the visibility enhancing substance 20 is a glow in the dark substance or glittering substance, preferably in form of small flecks or particles. This allows for easy avoidance or collection at night or in the dark.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from the spirit of the invention.

What is claimed:

1. A pet food formulation which is adapted for affecting the visibility of a pet's excrement that comprises the following ingredients: a glow in the dark substance,
wherein said glow in the dark substance comprises at least 0.1 percent of the formulation by weight.

2. The pet food formulation of claim 1, wherein said glow in the dark substance comprises at least 0.5 percent of the formulation by weight.

3. The pet food formulation of claim 1, wherein said glow in the dark substance comprises at least 1.0 percent of the formulation by weight.

4. The pet food formulation of claim 1, wherein said glow in the dark substance comprises at least 1.5 percent of the formulation by weight.

5. A method for affecting the visibility of a pet's excrement comprising the steps of:
providing the pet with a food product,
providing a food coloring,
providing an outdoor environment,
applying the food coloring to the food product,
allowing the pet access to said outdoor environment for defecation, and
collecting or avoiding said pet's excrement.

6. The method for affecting the visibility of a pet's excrement of claim 5, wherein at least 5 grams of food coloring is provided for every 1000 grams of food product provided.

7. The method for affecting the visibility of a pet's excrement of claim 5, wherein at least 10 grams of food coloring is provided for every 1000 grams of food product provided.

8. The method for affecting the visibility of a pet's excrement of claim 5, wherein at least 15 grams of food coloring is provided for every 1000 grams of food product provided.

9. A food product which is adapted for affecting the visibility of an animal's excrement that comprises the following ingredients: a meat, and a food coloring,
wherein said food product is comprised of at least 0.1 percent of said food coloring by weight.

10. The food product of claim 9, wherein said food coloring comprises at least 0.5 percent of the food product by weight.

11. The food product of claim 9, wherein said food coloring comprises at least 1.0 percent of the food product by weight.

12. The food product of claim 9, wherein said food coloring comprises at least 1.5 percent of the food product by weight.
